(19) United States
(12) Patent Application Publication
(10) Pub. No.: US 2015/0358936 A1
(43) Pub. Date: Dec. 10, 2015

(54) METHOD OF ESTIMATING A POSITION OF A SIGNAL SOURCE, AND SERVER AND MOBILE DEVICE UTILIZING THE SAME

(71) Applicant: AthenTek Incorporated, Taipei City (TW)

(72) Inventors: Hao-Jen KAO, Taipei City (TW); Chun-Nan CHEN, Taipei City (TW)

(21) Appl. No.: 14/476,673

(22) Filed: Sep. 3, 2014

Related U.S. Application Data
(60) Provisional application No. 62/008,442, filed on Jun. 5, 2014.

(51) Int. Cl. H04W 64/00; G01S 5/02

(52) U.S. Cl. CPC H04W 64/00; G01S 5/0278

(57) ABSTRACT

A method of estimating a position of the signal source and a server and a mobile device utilizing the same are provided. The method, adopted by a computing device, includes: collecting a plurality of signal strengths of a signal source from a plurality of positions; fitting a curve to the pluralities of signal strengths and positions; and determining the position of the signal source based on the fitted curve.

### CROSS REFERENCE TO RELATED APPLICATIONS

This Application claims priority of U.S. Provisional Application No. 62/008,442, filed on Jun. 5, 2014, and the entirety of which is incorporated by reference herein.

### BACKGROUND OF THE INVENTION

1. Field of the Invention

The present invention relates to signal processing, and in particular it relates to a server and device which estimates the position of a signal source using curve-fitting, and a method thereof.

2. Description of the Related Art

Certain mobile devices can determine their geographic location by navigation signals from a satellite system (e.g., global positioning system or GPS) or an assistant navigation system (e.g., Assistant GPS or AGPS). In many places, the GPS signals can be nonexistent, weak, or subject to interference, such that it is not possible to accurately determine a location using the GPS functions of a mobile device. In such cases, the mobile device can determine its location using other navigation technologies. For example, if the location of a wireless transmitter (e.g., a base station or an access point) is known, and the mobile device can detect the signals of the wireless transmitter, the mobile device can then estimate a current location using the location of the detected wireless transmitter.

In some areas, the locations of the wireless transmitters are unknown. As a consequence, a method, a server, and a mobile device are provided to estimate the position of the wireless transmitters or the signal source.

### BRIEF SUMMARY OF THE INVENTION

A detailed description is given in the following embodiments with reference to the accompanying drawings.

An embodiment of a method is described, adopted by a computing device, including collecting a plurality of signal strengths of a signal source from a plurality of positions; fitting a curve to the pluralities of signal strengths and positions; and determining a position of the signal source based on the fitted curve.

Another embodiment of a server is disclosed, including a transceiver and a controller. The transceiver is configured to receive a plurality of signal strengths of a signal source and a plurality of corresponding positions from a plurality of mobile devices. The controller is configured to fit a curve to the pluralities of signal strengths and corresponding positions; and determine a position of the signal source based on the fitted curve.

An embodiment of a mobile device is provided, including a transceiver and a controller. The transceiver is configured to detect a plurality of signal strengths of a signal source from a plurality of positions. The controller is configured to fit a curve to the pluralities of signal strengths and positions; and determine a position of the signal source based on the fitted curve.

### BRIEF DESCRIPTION OF THE DRAWINGS

The present invention can be more fully understood by reading the subsequent detailed description and examples with references made to the accompanying drawings, wherein:

FIG. 1 is a block diagram of a positioning system 1 according to an embodiment of the invention;

FIG. 2 is a 3D contour plot of measurement positions against measured signal strengths according to an embodiment of the invention;

FIG. 3 is a flowchart of a position estimation method 3 according to another embodiment of the invention;

FIG. 4 is a block diagram of the positioning server 16 in FIG. 1; and

FIG. 5 is a block diagram of the mobile station 12 in FIG. 1.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Various aspects are described herein in connection with a mobile station, which can also be referred to as a mobile device, system, device, wireless terminal, subscriber unit, subscriber station, mobile, remote station, remote terminal, access terminal, user terminal, terminal, communication device, wireless device, portable communication device, wireless communication device, user agent, user device, or user equipment (UE). The mobile station may be a cellular telephone, a smartphone, a Session Initiation Protocol (SIP) phone, Personal Digital Assistant (PDA), a tablet computer, a laptop computer, a handheld device having wireless connection capability, a computing device, or another processing device connected to a wireless modem and a positioning module.

A signal source whose position is to be determined as described herein is a wireless transmitter, including a cellular base station, a node B, an evolved node B (eNB) or an access point.

The wireless communication network described herein may be a circuit switching (CS) or packet switching (PS)-based wireless communication system such as Global System for Mobile Communications (GSM), General packet radio service (GPRS), Enhanced Data rates for GSM Evolution (EDGE), Universal Mobile Telecommunications System (UMTS), Code Division Multiple Access 2000 (CDMA2000), Enhanced Voice- Data Optimized (EVDO), High Speed Packet Access (HSPA), HSPA plus (GSPA+), Time Division-Synchronous Code Division Multiple Access (TD-SCDMA), Worldwide Interoperability for Microwave Access (WiMAX), Long Term Evolution (LTE), and LTE- Advanced (LTE-A) systems.

A “position” or “location” as referred to herein is information associated with the whereabouts of an object according to a point of reference. Such a location may be represented as geographic coordinates such as latitude and longitude. Alternatively, such a position or location may be represented as a street address, municipality or other governmental jurisdiction, postal/zip code and the like. Examples of location representations according to embodiments and claimed subject matter are not limited in these respects.

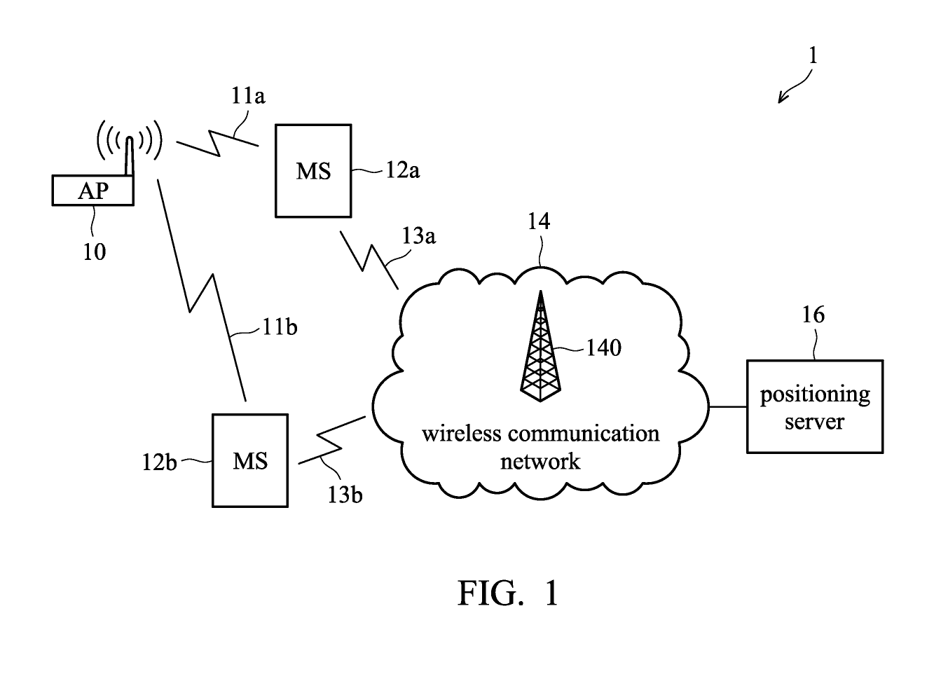

FIG. 1 is a block diagram of a positioning system 1 according to an embodiment of the invention, including an access point (AP) 10 (signal source), mobile stations (MS) 12a and 12b (mobile device), a wireless communication network 14, and a positioning server 16.

The AP 10 allows authenticated wireless devices to connect to a communication network using WiFi, WLAN, or other wireless communication standards. The MS 12a and 12b contains positioning modules (not shown) which allow the MS to determine its location based on navigation signals from an Assisted GPS (A-GPS), Assisted Global Navigation Satellite System (A-GNSS), Observed Time Difference Of Arrival (OTDOA), and other location service systems. The MS 12a and 12b may respectively establish wireless connections 13a and 13b to the wireless communication network 14 via a base station 140 and upload data to the positioning server 16 through the wireless connections 13a and 13b.

As the AP 10 operates, the nearby MS 12a and/or 12b may detect radio frequency (RF) signals of the AP 10 from a number of locations. The MS 12a and/or 12b may then measure the signal strengths of the RF signals. The position of the AP 10 may be determined based on the measured signal strengths and the corresponding locations where the signal strength measurements are taken. The MS 12a and 12b may determine the corresponding location by the built-in positioning modules. Furthermore, the RF signals may carry identifier information of the AP 10.

Although the MS 12a and 12b only measure the RF signals emitted from the AP 10 in FIG. 1, those skilled in the art will recognize that the MS 12a and 12b may measure signal strengths of RF signals from other signal sources as they move from place to place, with each signal source being identified by the identifier information.

In some embodiments, the location of the signal source is determined by the positioning server 16. As such, the MS 12a and 12b may upload the detected signal strengths along with the geographic coordinates where the signal strengths are detected to the positioning server 16. The MS 12a and 12b may also send the identifier information of the signal source to the positioning server 16. In turn, the positioning server 16 can fit a predetermined curve to the received data corresponding to the same signal source. The predetermined curve may represent a first degree, second degree, other degrees of polynomial equations, or a Gaussian function. The positioning server 16 can use the fitted curve to determine the position of the signal source, e.g., the position of the AP 10. Since the signal strength should peak at the center of the signal source, the positioning server 16 can determine the position of the maximum signal strength as the position of the signal source. Specifically, the positioning server 16 can determine the maximum signal strength on the fitted curve and estimate a position (first position) where the maximum signal strength occurs as the position of the signal source. The position and the identifier of the signal source may be stored in a location database in local memory of the positioning server 16 for further uses.

In other embodiments, the location of the signal source is determined by the MS 12a or 12b. The MS 12a or 12b can collect a plurality of signal strengths of the signal source as it moves within the radio coverage of the signal source. The MS 12a or 12b may record the plurality of collected signal strengths and the corresponding measurement locations in a local memory. After two or more signal-strength measurements are taken, the MS 12a or 12b can fit a predetermined curve to the recorded data of the same signal source. The predetermined curve may represent a first degree, second degree, other degrees of polynomial equations, or Gaussian function. The MS 12a or 12b can use the fitted curve to determine the position of the signal source, e.g., a position of the AP 10. Since the signal strength should peak at the center of the signal source, the MS 12a or 12b can determine the position of the maximum signal strength as the position of the signal source. Specifically, the MS 12a or 12b can determine the maximum signal strength on the fitted curve and estimate a position (first position) where the maximum signal strength occurs as the position of the signal source. Later, the MS 12a or 12b may upload the estimated position of the signal source along with the identifier information of the signal source to the positioning server 16. The position and the identifier of the signal source may be stored in a location database in local memory of the positioning server 16 for further uses.

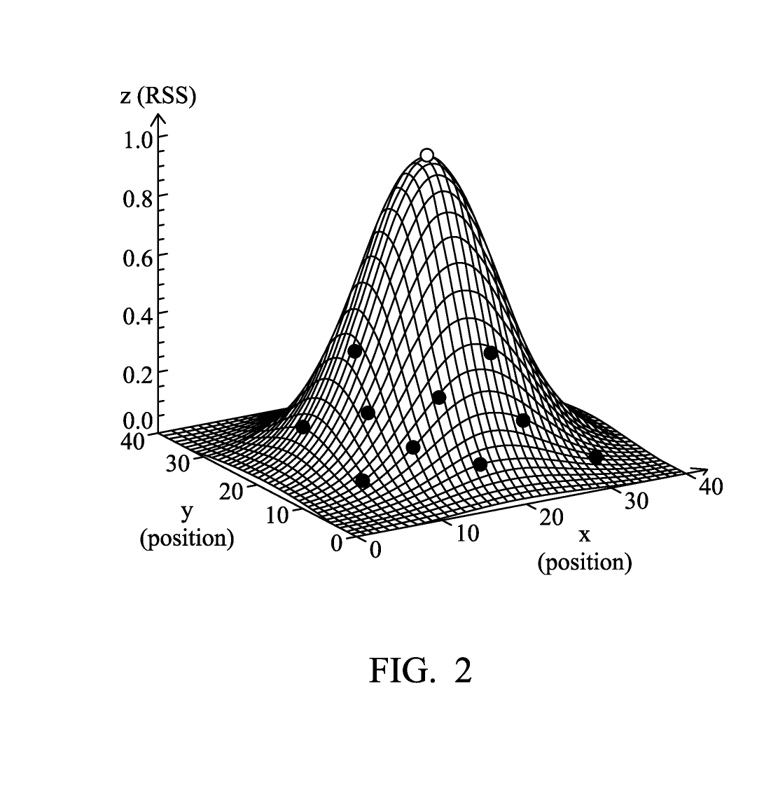

The curve-fitting operation according to an embodiment of the invention is exemplified in FIG. 2, which shows a 3D contour plot of measurement positions against measured signal strengths. In the 3D contour plot, the z axis represents the received signal strengths (RSS) of the received signal, the x and y axes represent the coordinates of the signal strength measurements, and the 3D contour shows a Gaussian function. The RSS may be a Received Signal Strength Indicator (RSSI) or the magnitude of the received signal.

Accordingly, the positioning server 16 or the MS 12a/12b may collect a plurality of signal strengths of a signal source from a plurality of positions close to the signal source. Conceptually, when performing Gaussian curve-fitting, the positioning server 16 or the MS 12a/12b may first plot the collected signal strengths of the signal source against the measurement positions on the 3-axes coordinates, indicated by solid dots in FIG. 2, and fit the Gaussian curve to most or all of the solid dots. The positioning server 16 or the MS 12a/12b may fit the Gaussian curve by interpolating, where the curve is fit to all the data points exactly, or smoothing, in which a “smooth” function is used to approximately fit all the data points. Once the Gaussian curve is fitted, the server 16 or the MS 12a/12b may determine a peak or maximum signal strength on the fitted Gaussian curve, indicated by a hollow dot in FIG. 2, estimate the position of the peak or maximum signal strength in form of xy coordinates, and determine the position of the peak or maximum signal strength as the position of the signal source.

Although the Gaussian curve is used in FIG. 2, other types of polynomial curves including first, second, and third degrees of polynomial may be employed in the curve-fitting procedure, and those skilled in the art may choose a curve which fits the property and characteristics of the collected data points to determine the position of a signal source.

After the position of the signal source is determined, the MS 12a/12b and other mobile stations may utilize the information of the signal source position to locate its whereabouts or perform other location-based services.

The positioning system in FIG. 1 employs the curve-fitting technique to estimate the location of a signal source, thereby establishing accurate location information for a number of signal sources.

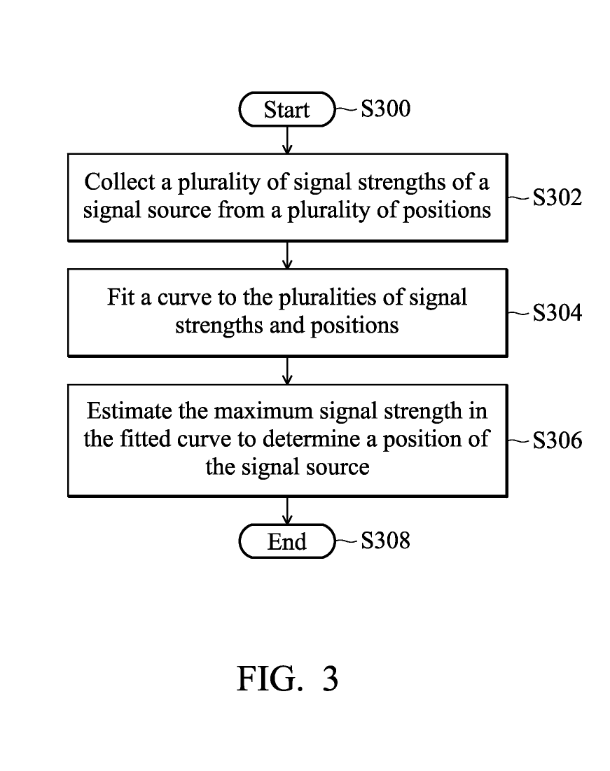

FIG. 3 is a flowchart of a position estimation method 3 according to another embodiment of the invention, adopted by a processing unit in a computing device such as the positioning server 16 or the MS 12a/12b in FIG. 1.

The position estimation method 3, implemented by an application or circuit, is initiated when the computing device is powered on or when the associated application is triggered (S300). The computing device then collects a plurality of signal strengths of a signal source from a plurality of positions (S302). The computing device collects the plurality of signal strengths by actively detecting the signal strengths of the signal source as moving from one place to another, or by simply receiving the signal strengths detected by a roaming mobile device. For example, the MS 12a/12b in FIG. 1 may collect the plurality of signal strengths by actively detecting the signal strengths of the signal source as moving from one place to another, and the positioning server 16 in FIG. 1 may collects the plurality of signal strengths by receiving the signal strengths of the signal source detected by one or more roaming mobile devices. In addition to the plurality of signal strengths, the computing device also obtains a plurality of positions where the signal strengths are detected. Moreover, the computing device may receive the identifier information of the signal source.

Subsequently, the computing device can fit a curve to the collected signal strengths and the corresponding measurement positions for the signal source (S304). The computing device can best fit the collected data of the signal strengths and the corresponding measurement positions to the curve by interpolating and/or smoothing the collected data. The curve may be a first degree, second degree, other degrees of polynomial equations, or Gaussian function. The computing device may select a type of curve to best fit the collected data. Further, the computing device may identify the collected data correspond to the same signal source by the identifier information.

The fitted curve is used to determine the position of the signal source by the computing device (S306). The computing device can estimate the maximum signal strength and the corresponding position on the fitted curve. The position corresponding to the maximum signal strength is determined as the position of the signal source. The computing device may store the position of the signal source and the identifier information of the signal source in a location database in local memory.

The positioning method in FIG. 3 employs the curve-fitting technique to estimate the location of a signal source, thereby establishing accurate location information for a number of signal sources.

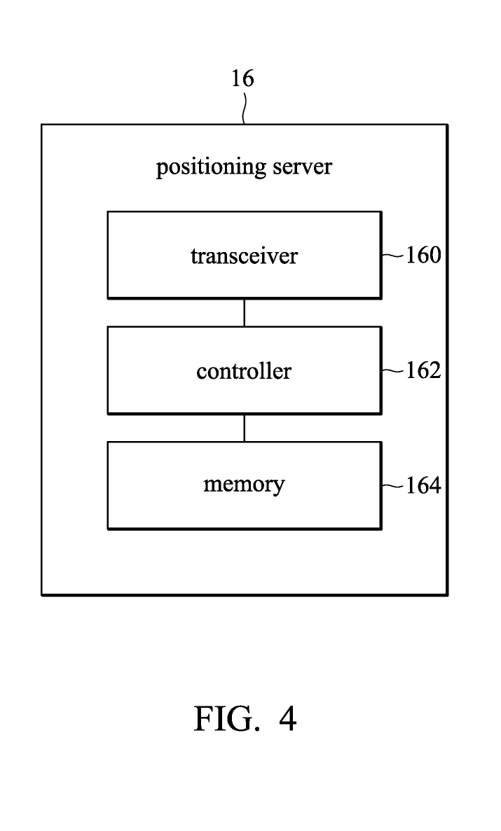

FIG. 4 is a block diagram of a positioning server 16 according to an embodiment of the invention, including a transceiver 160, a controller 162, and a memory 164. The positioning server 16 may be on a cloud server which provides location services and/or network services. The positioning server 16 can collect data from mobile devices which subscribe to the service, determine a position of a signal source based on the collected data, and establish a list of positions of all available signal sources.

The transceiver 160 is configured to receive a plurality data from one or more mobile devices, each data includes a signal strength of a signal source and a corresponding position where the signal strength is detected. The data may also include identifier information of the signal source. The mobile devices may collect the data as they move in the coverage of the signal source. The transceiver 160 may receive the data via a wired and/or wireless connection.

The controller 162 is configured to fit a curve to the pluralities of data; and determine a position of the signal source based on the fitted curve. The curve may represent a first degree, second degree, other degrees of polynomial equations, or Gaussian function. The controller 162 may select a type of curve to best fit the received data based on the characteristics of the data. Later, the controller 162 is configured to determine the position of the signal source by estimating a first position where a maximum signal strength occurs in the fitted curve.

The controller 162 then stores the estimated first position and identifier information of the signal source into a location database in the memory 164 for later use, e.g., locating a mobile device based on the position of the signal source and a signal strength of the signal source picked up by the mobile device.

The positioning server 16 in FIG. 4 employs the curve-fitting technique to estimate the location of a signal source, thereby establishing accurate location information for a number of signal sources. The positioning server 16 can further utilize the established location information of signal sources to provide location services to subscribed mobile devices.

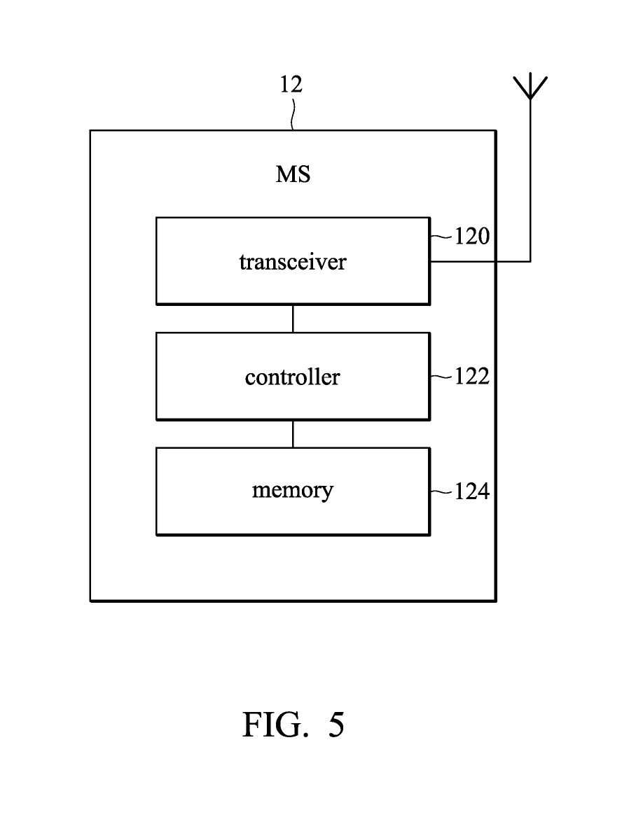

FIG. 5 is a block diagram of a mobile station 12 according to an embodiment of the invention, including a transceiver 120, a controller 122, and a memory 124. The mobile station 12 can collect signal strengths of a signal source as it moves from one place to another, and determine a position of a signal source based on the collected data.

The transceiver 120 can transmit or receive RF signals via an antenna. The transceiver 120 is configured to detect an RF signal originated from a signal source from a plurality of locations and measure a plurality of signal strengths of the RF signal that are detected in the plurality of locations. Next, the transceiver 120 can pass the plurality of data of the signal strengths and the corresponding measurement locations to the controller 122. The transceiver 120 can detect an RF signal as it move in the coverage of the signal source.

The controller 122 is configured to fit a curve to the pluralities of data; and determine a position of the signal source based on the fitted curve. The curve may represent a first degree, second degree, other degrees of polynomial equations, or Gaussian function. The controller 122 may select a type of curve to best fit the received data based on the characteristic of the data. Later, the controller 122 is configured to determine the position of the signal source by estimating a first position where a maximum signal strength occurs in the fitted curve.

In some embodiments, the controller 122 may store the estimated first position and identifier information of the signal source into the local memory 164 for later uses, e.g., locating the position of the mobile station 12 based on the position of the signal source and a signal strength of the signal source detected by the transceiver 120. In other embodiments, the transceiver 120 may send the estimated first position along with the identifier information of the signal source via one or more communication networks to the positioning server 16, where the first position and the identifier information of the signal source are stored, so that later, the positioning server 16 may locate a mobile device based on the position of the signal source and a signal strength of the signal source picked up by the mobile device.

The mobile station 12 in FIG. 5 employs the curve-fitting technique to estimate the location of a signal source, thereby establishing accurate location information for a number of signal sources. Moreover, the mobile station 12 can later utilize the established location information of signal sources to accurately determine its current location.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application-specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, micro controller or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method, adopted by a computing device, comprising:
collecting a plurality of signal strengths of a signal source from a plurality of positions;
fitting a curve to the pluralities of signal strengths and positions; and
determining a position of the signal source based on the fitted curve.

2. The method of claim 1, wherein the position of the signal source is located at a first position where a maximum signal strength in the fitted curve is estimated.

3. The method of claim 1, wherein the curve represents a first degree polynomial equation.

4. The method of claim 1, wherein the curve represents a second degree polynomial equation.

5. The method of claim 1, wherein the curve represents a Gaussian function.

6. A server, comprising:
a transceiver, configured to receive a plurality of signal strengths of a signal source and a plurality of corresponding positions from a plurality of mobile devices; and
a controller, configured to fit a curve to the pluralities of signal strengths and corresponding positions; and determine a position of the signal source based on the fitted curve.

7. The server of claim 6, wherein the controller is configured to determine the position of the signal source by estimating a first position where a maximum signal strength occurs in the fitted curve.

8. The server of claim 6, wherein the curve represents a first degree polynomial equation.

9. The server of claim 6, wherein the curve represents a second degree polynomial equation.

10. The server of claim 6, wherein the curve represents a Gaussian function.

11. A mobile device, comprising:
a transceiver, configured to detect a plurality of signal strengths of a signal source from a plurality of positions; and
a controller, configured to fit a curve to the pluralities of signal strengths and positions; and determine a position of the signal source based on the fitted curve.

12. The mobile device of claim 11, wherein the controller is configured to determine the position of the signal source by estimating a first position where a maximum signal strength occurs in the fitted curve.

13. The mobile device of claim 11, wherein the curve represents a first degree polynomial equation.

14. The mobile device of claim 11, wherein the curve represents a second degree polynomial equation.

15. The mobile device of claim 11, wherein the curve represents a Gaussian function.
